(19) United States
(12) Patent Application Publication
(10) Pub. No.: US 2002/0039154 A1
(43) Pub. Date: Apr. 4, 2002

(54) FRAME PLATE WITH HIGHER RIGIDITY AND THINNER EDGES FOR HOLDING A DISPLAY

(76) Inventor: TOMOO MIWA, TOKYO (JP)

Correspondence Address: PAUL J ESATTO JR, SCULLY SCOTT MURPHY & PRESSER, 400 GARDEN CITY PLAZA, GARDEN CITY, NY, 11530

(21) Appl. No.: 09/333,609

(22) Filed: Jun. 15, 1999

(30) Foreign Application Priority Data
Jul. 9, 1998 (JP) 194231/1998

(51) Int. Cl. G02F 1/1333

(52) U.S. Cl. 349/58

(57) ABSTRACT

A display panel unit composed of a display panel for displaying image data and a frame plate for holding the display panel is pivotably attached to the main unit of an electronic apparatus by hinge units. Hinge support members that support the hinge units are provided in the frame plate. Force that would otherwise act to bend the frame plate when pivoting the display is received by the hinge support members.

### BACKGROUND OF THE INVENTION

1. Field of the Invention

The present invention relates to a display that is pivotably mounted on the main unit of an electronic apparatus such as a notebook PC.

2. Description of the Related Art

As shown in FIG. 1, a conventional display 101 of this kind includes a display panel 102 for displaying images and a frame plate 103 for holding display panel 102. Display 101 is mounted on an electronic apparatus such as a notebook PC (not shown), and is configured, for example, in the form of a liquid crystal display. Two securing portions 103a are provided on the two sides of frame plate 103 for attaching display 101 to the main unit of the electronic apparatus.

Display 101 is attached to the main unit of the electronic apparatus by attaching fixing portions 104a of hinges 104 to securing portions 103a of frame plate 103 by, for example, screws, and then securing fixing portions 104c of hinges 104 to the main unit of electronic apparatus.

Display 101, which is attached to the main unit of the electronic apparatus is pivotable about pivots 104b for opening and closing with respect to the main unit of the electronic apparatus.

Since the conventional display is of a construction in which the hinges are attached directly to the frame plate, pivoting the display by holding a side thereof causes the frame plate to bend, which may cause the display panel to warp and produce color irregularities and stripes in the displayed image.

In addition, the provision of securing portions for attaching hinges on the frame plate of the display imposes a limit on the minimum width of the frame of the frame plate. This limit is an obstacle to designs directed toward a thinner frame plate, for example when making the frame of a frame plate as thin as possible to provide a display panel with a larger screen.

In addition, when attaching the conventional display to the main unit of the electronic apparatus, attaching hinges to securing portions at two positions is required, thus increasing the number of steps to assemble the electronic apparatus.

### SUMMARY OF THE INVENTION

It is an object of the present invention to provide a display that can reduce warping of the display panel when pivoting, that allows a frame plate in which the frame is made thinner, and that allows a reduction in the number of assembly steps.

According to one aspect of the present invention, the display includes: a pivoting means for pivotably attaching a display panel unit, which is composed of a display panel for displaying image data and a frame plate for holding the display panel, to the main unit of an electronic apparatus; and a pivoting means support member provided in the frame plate for supporting the pivoting means.

The pivoting means support member receives the force that would otherwise act to bend the frame plate when pivoting the display and therefore enables a suppression of the bending of the frame plate, thereby reducing warping of the display panel and the incidence of color irregularities or stripes in the displayed image. In contrast to the prior art having the construction in which the pivots were provided directly on the frame plate, the frame of the frame plate can be made thinner, thereby enabling a thinner frame plate.

The aforementioned frame plate, pivoting means support member, and pivoting means may be formed as a single unit. Such a construction eliminates the step of attaching pivots to the frame plate when attaching the display to the main unit of the electronic apparatus and therefore allows a reduction in the number of assembly steps of the electronic apparatus.

In addition, the pivoting means may be a hinge made up of: a display-side fixture to be fixed to the pivoting means support member; a main unit-side fixture to be fixed to the main unit of the electronic apparatus; and a pivot for allowing one of the two fixtures to pivot with respect to the other.

According to another aspect of the invention, the display includes: a base to which is attached a display panel unit composed of a display panel for displaying image data and a frame plate for holding the display panel; and a pivotable securing means for attaching the base to the main unit of the electronic apparatus in a freely pivotable manner. Such a construction enables a suppression of bending of the frame plate because the base receives the force that would otherwise act to bend the frame plate when the display is pivoted.

The pivotable securing means may be embodied as a screw.

Finally, the display panel may be a liquid crystal display panel, a plasma display panel, or an EL (Electro-luminescence) display panel.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a perspective view of a display of the prior art;

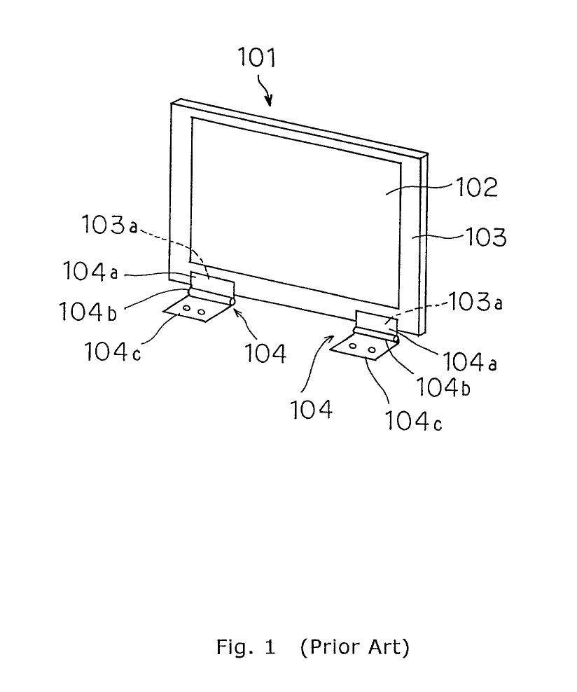

FIG. 2 is an exploded perspective view showing a display according to one embodiment of the present invention;

FIG. 3 is an enlarged perspective view of the hinge shown in FIG. 1; and

FIG. 4 is a perspective view showing a display according to another embodiment of the present invention.

### DETAILED DESCRIPTION OF THE PREFERRED EMBODIMENTS

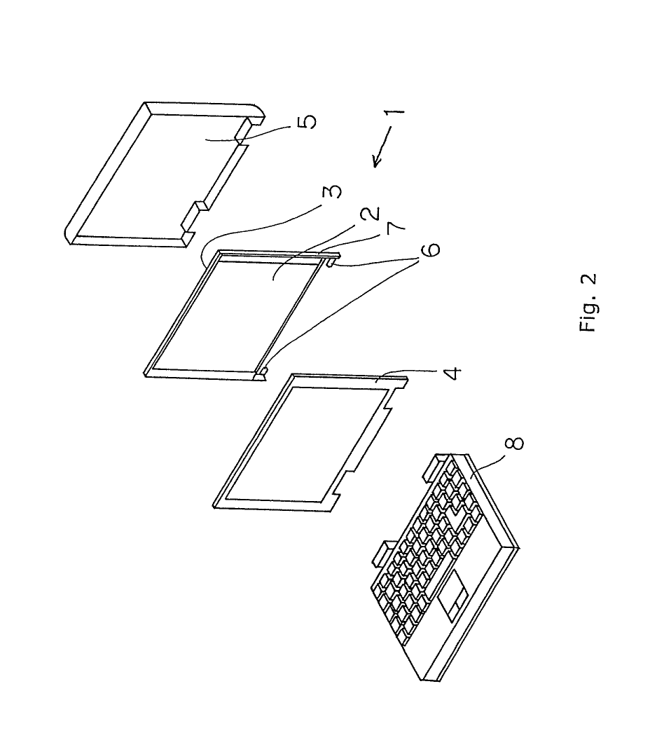

Referring now to FIG. 2, there is shown a display according to an embodiment of the present invention, generally designated 1, comprising display panel 2 for displaying an image and frame plate 3 for holding display panel 2. Display panel 2 and frame plate 3 constitute the display panel unit. On both sides of frame plate 3, hinge support members 7 that act as the pivoting means support members are provided as a single unit with frame plate 3, and hinge support members 7 are in turn provided with hinge units 6 that act as the pivoting means.

Display panel 2, which is supported by frame plate 3, is accommodated inside frame plate 3 with sandwiched between base 5, to which display panel 2 is attached, and cover 4, which covers display panel 2.

Hinge units 6 on frame plate 3 are fixed to main unit 8 of the electronic apparatus (a notebook PC in this embodiment).

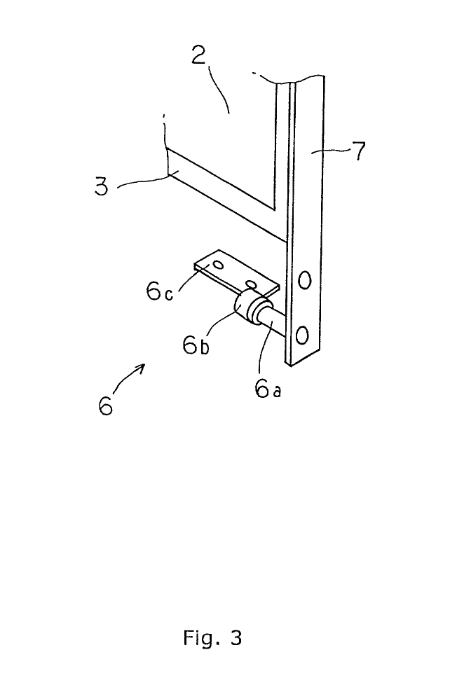

As shown in FIG. 3, each of hinge units 6 consists of: display-side fixture 6a fixed to and supported by hinge support member 7; main unit-side fixture 6c secured to main unit 8 by, for example, screws; and pivot 6b by which fixture 6a is pivoted with respect to fixture 6c.

Display 1 constituted as described above is attached to main unit 8 by securing main unit-side fixtures 6c of hinge units 6 to main unit 8 of the electronic apparatus. Display 1 which is attached to main unit 8, pivots about pivots 6b of hinge units 6 to be freely opened and closed with respect to main unit 8.

In this embodiment, the force that tends to bend frame plate 3 when pivoting display 1 is received by hinge support member 7. This construction suppresses bending of frame plate 3, and consequently, allows a reduction in the color irregularities or stripes which may be caused by warping of display panel 2. In contrast to the prior art having the construction in which hinges are provided directly on the frame plate, this embodiment includes hinge units 6 on frame plate 7 by way of hinge support members 7, whereby the width of the frame of frame plate 3 can be reduced and the frame plate made with thinner edges.

Further, the provision of hinge support members 7 with hinge units 6 as a single unit with frame plate 3 in this embodiment, eliminates the need to attach hinge units 6 to frame plate 3 when attaching display 1 to main unit 8 and thus allows a reduction in the assembly steps of the electronic apparatus.

Various types of display panel panels, including a liquid crystal display panel, a plasma display panel, and an EL display panel, may be employed as display panel 2 in this embodiment. In addition, although an example has been described in which two hinge units 6 are provided on the two sides of frame plate 3, the number of hinge units provided on frame plate 3 is not limited to two.

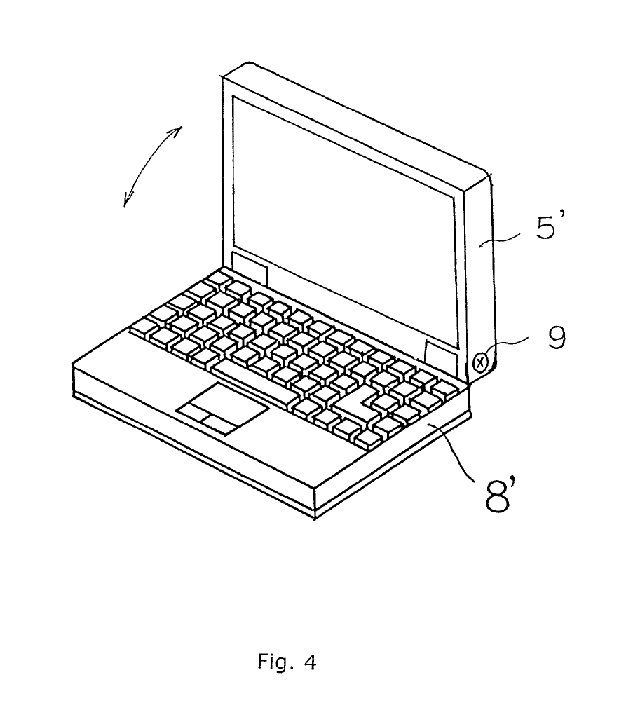

In this embodiment, moreover, an example was described in which display 1 was attached to main unit 8 of an electronic apparatus by way of hinge units 6 provided on hinge support members 7. As shown in FIG. 4, however, a construction may also be adopted in which the sides of base 5′ are freely pivotably attached to the sides of main unit 8′ of the electronic apparatus by a pivotable securing means, for example, in the form of screws 9. This constitution simplifies the construction of the periphery of the frame plate and allows the frame plate of a display to be made with even thinner edges.

While preferred embodiments of the present invention have been described using specific terms, such description is for illustrative purposes only, and it is to be understood that changes and variations may be made without departing from the spirit or scope of the following claims.

What is claimed is:

1. A display comprising:
a display panel unit composed of a display panel for displaying image data and a frame plate for holding said display panel
a pivoting means for pivotably attaching said display panel unit to the main unit of an electronic apparatus; and
a pivoting means support member provided in said frame plate for supporting said pivoting means.

2. A display according to claim 1 wherein said frame plate, said pivoting means support member, and said pivoting means are formed as a single unit.

3. A display according to claim 1 wherein said pivoting means is a hinge made up of: a display-side fixture to be fixed to said pivoting means support member; a main unit-side fixture to be fixed to said main unit of said electronic apparatus; and a pivot for pivoting one of said two fixtures with respect to the other.

4. A display comprising:
a display panel unit composed of a display panel for displaying image data and a frame plate for holding said display panel
a base to which said display panel unit is attached; and
a pivotable securing means for attaching said base to said main unit of said electronic apparatus in a freely pivotable manner.

5. A display according to claim 4 wherein said pivotable securing means is constituted by a screw.

6. A display according to claim 1 wherein said display panel is a liquid crystal display panel.

7. A display according to claim 2 wherein said display panel is a liquid crystal display panel.

8. A display according to claim 3 wherein said display panel is a liquid crystal display panel.

9. A display according to claim 4 wherein said display panel is a liquid crystal display panel.

10. A display according to claim 5 wherein said display panel is a liquid crystal display panel.

11. A display according to claim 1 wherein said display panel is a plasma display panel.

12. A display according to claim 2 wherein said display panel is a plasma display panel.

13. A display according to claim 3 wherein said display panel is a plasma display panel.

14. A display according to claim 4 wherein said display panel is a plasma display panel.

15. A display according to claim 5 wherein said display panel is a plasma display panel.

16. A display according to claim 1 wherein said display panel is an EL (Electro-luminescence) display panel.

17. A display according to claim 2 wherein said display panel is an EL (Electro-luminescence) display panel.

18. A display according to claim 3 wherein said display panel is an EL (Electro-luminescence) display panel.

19. A display according to claim 4 wherein said display panel is an EL (Electro-luminescence) display panel.

20. A display according to claim 5 wherein said display panel is an EL (Electro-luminescence) display panel.
